(19) United States
(12) Patent Application Publication
(10) Pub. No.: US 2010/0135366 A1
(43) Pub. Date: Jun. 3, 2010

(54) DATA EQUALISATION IN A COMMUNICATION RECEIVER WITH RECEIVE DIVERSITY

(75) Inventors: Allen Yuan, Tokyo (JP); Thanh Bui, Tokyo (JP); Holly He, Tokyo (JP)

Correspondence Address: YOUNG & THOMPSON, 209 Madison Street, Suite 500, Alexandria, VA, 22314, US

(73) Assignee: NEC Corporation, Tokyo (JP)

(21) Appl. No.: 12/521,164

(22) PCT Filed: Dec. 12, 2007
(86) PCT No.: PCT/JP2007/074354

§ 371 Date: Jan. 12, 2010

(30) Foreign Application Priority Data
Dec. 28, 2006 (AU) 2006907316

(51) Int. Cl. H04B 1/707

(52) U.S. Cl. 375/148; 375/E01.002

(57) ABSTRACT

A method of performing data equalisation in a communication receiver with transmit and receive diversity includes (a) for each i-th receiver antenna and j-th transmitter antenna, calculating a channel response matrix H_{i,j} from multi-path channel estimates, (b) each i-th receiver antenna, calculating a channel gain matrix Gᵢ from the channel response matrices H_{i,j} and a scalar noise factor β, (c) calculating the middle column c₀ of Gᵢ⁻¹, (d) calculating a filter coefficient vector w_{i,j} from the middle column c₀ of Gᵢ⁻¹ and the Hermitian transpose H_{i,j}^{H} of the corresponding channel response matrices H_{i,j}, (e) filtering input data rᵢ received at each i-th receiver antenna with the corresponding filter coefficient vectors w_{i,j}, (f) despreading the filtered input data from each i-th receiver antenna, (g) applying phase compensation to the despread data, and (h) combining the despread data from all antennas to obtain received equalised data.

The present invention relates generally to spread spectrum receivers, and in particular to methods of optimising the equalisation in a communication receiver, with receive diversity, of a spread spectrum signal transmitted through multiple resolvable fading paths channel. The invention is suitable for use in applications involving W-CDMA transmission techniques, and it will be convenient to describe the invention in relation to that exemplary application.

In W-CDMA communication systems, multicode signals at the transmitter are orthogonal to each other. However, this orthogonality is lost as the signals propagate through a multi-path fading channel. A chip equaliser is employed in the W-CDMA receiver as a means to restore the orthogonality of the signal, and thereby improve the receiver performance.

Typically, implementations of chip equalisers include a finite impulse response (FIR) filter. The chip equaliser tries to compensate for multi-path interference by inverting the channel. A known method for computing optimal chip equaliser filter coefficients uses a direct inversion matrix method involving estimation of the channel gain matrix G from the expression G=H^{H}H+βI, where H^{H}H is the channel correlation matrix, I is identity matrix, and β is a scalar noise factor in a W-CDMA system. Chip level equalisation based on the matrix inversion method requires extensive computation that involves matrix decomposition as well as backward and forward substitution.

In current 3rd generation partnership project (3GPP) standards, receive diversity is used to improve receiver downlink performance. Receive diversity uses multiple antennas at the receiver to enable stronger signal reception. This translates to higher data rates and increases system capacity. Current 3GPP standards specify requirements for receivers based on a least minimum mean-square error (LMMSE) chip level equaliser (CLE). Whilst implementation of the CLE is straightforward in the case of a communication system without transmit or receive diversity, implementation of the CLE in a communication receiver with receive diversity has yet to be implemented in a practical, computationally efficient manner.

There currently exists a need to provide a method of performing data equalisation in a communication receiver with receive diversity that ameliorates or overcomes one or more disadvantages of the prior art. There also exists a need to provide a method of performing data equalisation in a communication receiver with receive diversity that optimizes the performance of a chip level equaliser in the communication receiver. There further exists a need to provide a method for performing data equalisation in a communication receiver which receive diversity that is simple, practical and computationally efficient to implement.

With this in mind, one aspect of the invention provides a method for performing data equalisation in a communication receiver forming part of a communication system with receive diversity, the method including the steps of:

(a) for each i-th antenna, calculating a channel response matrix Hᵢ from multi-path channel estimates;

(b) calculating a channel gain matrix G from the channel response matrices Hᵢ and a scalar noise factor β;

(c) calculating the middle column c₀ of the inverse G⁻¹ of the channel gain matrix G;

(d) for each i-th antenna, calculating a filter coefficient vector wᵢ from the middle column c₀ of the inverse G⁻¹ of the channel gain matrix G and the Hermitian transpose Hᵢ^{H} of the corresponding channel response matrix Hᵢ;

(e) filtering input data rᵢ received at each i-th antenna with the corresponding filter coefficient vector wᵢ;

(f) despreading the filtered input data from each i-th antenna; and

(g) combining the despread data from all antennas to obtain received equalised data.

Preferably, step (c) includes:

(h) performing a Cholesky decomposition of the channel gain matrix G into a lower triangular matrix L and an upper triangular matrix U;

(i) performing forward substitution on the lower triangular matrix L to calculate a column vector d; and

(j) performing backward substitution on the column vector d and the Hermitian transpose L^{H} of the lower triangular matrix L to calculate the middle column c₀ of the inverse G⁻¹ of the channel gain matrix G.

Preferably, the channel gain matrix G to be inverted is calculated from the expression

G=Σ₁ⁱĤᵢ^{H}Ĥᵢ+\tilde{β}I

where I is the identity matrix.

Another aspect of the invention provides a chip equaliser for use in a communication receiver forming part of a communication system with receive diversity, the chip equaliser including one or more computational blocks for implementing the above described method.

The following description refers in more detail to various features of the invention. To facilitate an understanding of the invention, reference is made in the description to the accompanying drawings where the method for performing data equalisation and the chip equaliser are illustrated in preferred embodiments. It is to be understood that the invention is not limited to the preferred embodiments as shown in the drawings.

In the drawings:

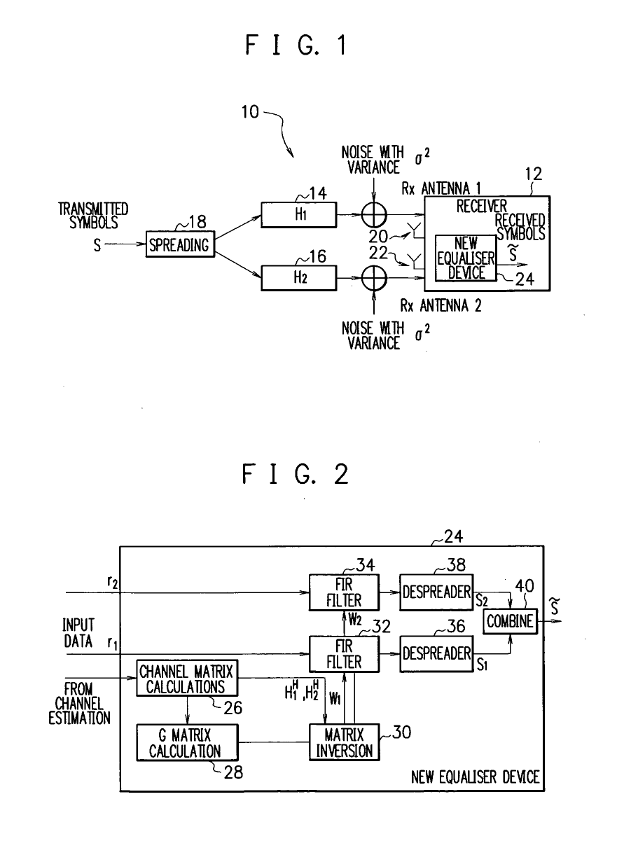

FIG. 1 is a schematic diagram of a communication system including a communication receiver with receive diversity;

FIG. 2 is a schematic diagram showing selected functional blocks of an equaliser for use in the communications receiver forming part of the communication system of FIG. 1;

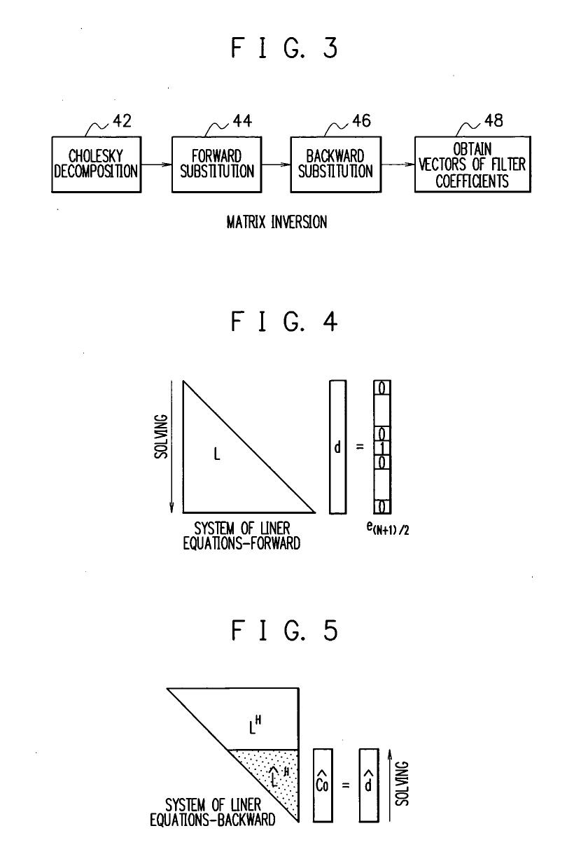

FIG. 3 is a flow chart showing a series of steps performed by a matrix inversion computational block for the equaliser shown in FIG. 2; and

FIGS. 4 and 5 are graphical representations respectively of the forward and backward substitution steps of the filter coefficient calculation method carried out by the equaliser shown in FIG. 2.

Referring now to FIG. 1, there is shown generally a communication system 10 for transmission of data symbols S to a communication receiver 12. The communication system 10 use a diversity scheme to improve the reliability of a message signal transmitted to the receiver 12 by using two or more communication channels with different characteristics. In the example illustrated in this figure, two communication channels 14 and 16 are illustrated. Each of the communication channels 14 and 16 experience different levels of fading and interference.

Following signal spreading 18, the data symbols are effectively transferred to the communication receiver 12 over different propagation paths by the use of multiple antennas at the communication receiver 12. In this example, two exemplary receiving antennas 20 and 22 are illustrated, but in other embodiments of the invention any number of receiving antennas may be used.

During transmission of the data symbols to the communication receiver 12, noise characterised by variance σ² is effectively introduced into the dispersive channels 14 and 16. The communications receiver 12 includes an equaliser 24 designed to restore the transmitted data signals distorted by the dispersive channels 14 and 16 and the noise introduced into those dispersive channels.

Selected computational blocks of the equaliser 24 are illustrated in FIG. 2. The equaliser 24 includes a channel response matrix calculation block 26, a direct gain matrix calculation block 28, a matrix inversion block 30, FIR filter blocks 32 and 34, despreader blocks 36 and 38 and a data symbol combining block 40. In use, the equaliser 24 receives samples rᵢ at each of the i receiver antennas, namely samples r₁ from the first reception antenna 20 and samples r₂ from the second reception antenna 22.

Channel estimates for the dispersive channel received at each i-th reception antenna are computed within the receiver 12 and provided as an input to the channel matrix calculation block 26. The channel estimates hₗⁱ, where l=0,1,2, . . . , L−1 are received by the channel matrix calculation block 26 for the L multiple resolvable fading paths of each transmission channel received by each i-th reception antenna.

The channel response matrix Ĥᵢ for each i-th receiver antenna is constructed from the received channel estimates by consecutively shifting a channel vector column by column, where the channel vector is formed by arranging the L channel estimates h₁ⁱ in their multi-path position in the direction of the column. In the example shown in FIG. 2, two such channel matrices are constructed.

A channel gain matrix G is then constructed based upon the estimate of the channel response matrices. H₁ and H₂ together with an estimate of the scale and noise factor in the communication system 10. The direct gain matrix G is calculated according to the following equation:

G=Ĥ₁^{H}Ĥ₁+Ĥ₂^{H}Ĥ₂+\tilde{β}I

where Ĥ₁ and Ĥ₂ are respectively the channel response matrices for the dispersive channels 14 and 16, Ĥ₁^{H} and Ĥ₂^{H} are respectively the hermitian transpose of those channel response matrices, \hat{β} an estimate of the noise factor of the communication system 10 and I is the identity matrix, Ĥᵢ^{H}Ĥᵢ is the channel correlation matrix for each i-th dispersive channel in the communication system 10. The estimate \hat{β} the noise factor in the communication system 10 can be computed by the receiver 12 in the manner described in United States Patent Application 2006/0018367, filed 19 Jul. 2005 in the name of NEC Corporation, the entire contents of which are incorporated herein by reference.

The channel gain matrix G must then be inverted in the matrix inversion block 30. A computationally efficient series of steps performed by the matrix inversion block 30 are illustrated in the flow chart shown in FIG. 3. At step 42, a Cholesky decomposition of the channel gain matrix G is performed to obtain a lower triangular matrix

L and an upper triangular matrix U.

At step 44, a forward substitution is then performed to solve the equation

Ld=e_{(N+1)/2}=[e₁, e₂, . . . , e_{N}]^{T} where eᵢ={1₀_{_{otherwise}}^{i=(N+1)/2} (3)

to obtain a column vector d. The lower triangular matrix L, the column vector d and the resultant column vector e are schematically represented in FIG. 4. Preferably, only half of this vector (denoted as a where \hat{d}=d[(N−1)/2, . . . ,N−1]) needs to be inputted into the next computational step.

At step 46, a backward substitution is then carried out to solve the equation

\hat{L}^{H}ĉ₀=\hat{d}

where

\hat{L}^{H}[i.j]=L^{H}[i+(N−1)/2, j+(N−1)/2]∀0≦i,j≦(N−1)/2

to obtain half of vector c₀ (denoted as ĉ₀) corresponding to the middle row of the matrix G⁻¹. FIG. 5 is a graphical illustration of the backward substitution step performed at this step. The full vector c₀ can then be obtained noting that

c₀[(N−1)/2+k]=ĉ₀[k], c₀[k]=c₀[N−1−k]*, k=0, . . . , (N−1)/2

At step 48, the vectors of filter coefficients wᵢ for each of the FIR filters 32 and 34 can be obtained by computing wᵢ=c₀^{H}Hᵢ^{H} for each i-th filter.

The input data rᵢ is periodically updated with filter coefficient vectors wᵢ during operation of the receiver 12. Despreader blocks 36 and 38 perform despreading operations on the input data symbol estimates from the multiple resolvable fading paths received respectively by the reception antennas 20 and 22. Accordingly, each despreader block obtains estimated symbols corresponding to each i-th receive antenna (denoted as Si).

The combining block 40 acts to combine the despread symbols from the receive antennas to obtain equalised data symbols {\tilde{S}(0), \tilde{S}(1), \tilde{S}(2) . . . }.

Since the linear equations solved in the forward substitution step 44 and backward substitution step 46 has N and (N+1)/2 unknowns, solving them only requires calculation complexity of 0(N²). This significantly reduced computational complexity and enables the use of the equaliser 24 in practical communication.

It will be appreciated from the foregoing that in a communication system, calculating the filter coefficients for an equaliser at the receiver using direct matrix inversion would normally require up to O(N³) complex multiplications for forward and backward substitutions processing, where N is dimension of the square channel matrix to be inverted. This high level of computational complexity is a prohibitive factor for this method to be used in practical communication device. The above-described equaliser uses an efficient method of calculation requiring only 0(N²) complex multiplications for forward and backward substitutions processing to obtain exactly the same performance as normal equaliser employing direct matrix inversion. The simplified calculation is achievable by exploiting the special property (Hermitian and Positive Definite) of the channel response matrix G as well as the way filter coefficients are calculated in a particular realisation of the equaliser receiver.

Finally, it should be appreciated that modifications and/or additions may be made to the equaliser and method of calculating filter coefficients for an equaliser without departing from the spirit or ambit of the present invention described herein.

This application is based upon and claims the benefit of priority from Australian patent application No. 2006907316, filed on Dec. 28, 2006, the disclosure of which is incorporated herein in its entirety by reference.

1-4. (canceled)

5. A method for performing data equalisation in a communication receiver forming part of a communication system with receive diversity, the method including the steps of:
(a) for each i-th antenna, calculating a channel response matrix Hᵢ from multi-path channel estimates;
(b) calculating a channel gain matrix G from the channel response matrices Hᵢ and a scalar noise factor β;
(c) calculating the middle column c₀ of the inverse G⁻¹ of the channel gain matrix G;
(d) for each i-th antenna, calculating a filter coefficient vector wᵢ from the middle column c₀ of the inverse G⁻¹ of the channel gain matrix G and the Hermitian transpose Hᵢ^{H} of the corresponding channel response matrix Hᵢ;
(e) filtering input data rᵢ received at each i-th antenna with the corresponding filter coefficient vector wᵢ;
(f) despreading the filtered input data from each i-th antenna; and
(g) combining the despread data from all antennas to obtain received equalised data.

6. A method according to claim 5, wherein step (c) includes:
(h) performing a Cholesky decomposition of the channel gain matrix G into a lower triangular matrix L and an upper triangular matrix U;
(i) performing forward substitution on the lower triangular matrix L to calculate a column vector d; and
(j) performing backward substitution on the column vector d and the Hermitian transpose L^{H} of the lower triangular matrix L to calculate the middle column c₀ of the inverse G⁻¹ of the channel gain matrix G.

7. A method according to claim 5, wherein the channel gain matrix G to be inverted is calculated from the expression
G=Σ₁ⁱĤᵢ^{H}Ĥᵢ+\tilde{β}I
where I is the identity matrix.

8. A chip equaliser for use in a communication receiver forming part of a communication system with receive diversity, the chip equaliser including one or more computational blocks for implementing a method according to claim 5.

9. A method according to claim 6, wherein the channel gain matrix G to be inverted is calculated from the expression
G=Σ₁ⁱĤᵢ^{H}Ĥᵢ+\tilde{β}I
where I is the identity matrix.

10. A chip equaliser for use in a communication receiver forming part of a communication system with receive diversity, the chip equaliser including one or more computational blocks for implementing a method according to claim 6.

11. A chip equaliser for use in a communication receiver forming part of a communication system with receive diversity, the chip equaliser including one or more computational blocks for implementing a method according to claim 7.

12. A chip equaliser for use in a communication receiver forming part of a communication system with receive diversity, the chip equaliser including one or more computational blocks for implementing a method according to claim 9.
